(19) United States
(12) Patent Application Publication
(10) Pub. No.: US 2007/0283485 A1
(43) Pub. Date: Dec. 13, 2007

(54) Wiper device for safety helmet

(76) Inventor: Hsien-Hao Tseng, Sijhih City (TW)

Correspondence Address: TROXELL LAW OFFICE PLLC;SUITE 1404, 5205 LEESBURG PIKE, FALLS CHURCH, VA, 22041, US

(21) Appl. No.: 11/449,717

(22) Filed: Jun. 9, 2006

(51) Int. Cl. A42B 1/08; B60S 1/56

(52) U.S. Cl. 2/424; 15/250.3; 15/250.31; 15/250.001

(57) ABSTRACT

The present invention provides a wiper device for safety helmet that comprises a helmet housing, a touch device, a drive and a wiper. When driving on a rainy day, a user's teeth occlude and come into contact with the touch device that actuates the drive through cables, thereby making the wiper oscillate on a surface of a glass plate so as to wipe rainwater off the surface of the glass plate and enhance the visibility and safety when driving on a rainy day.

### BACKGROUND OF THE INVENTION

(a) Field of the Invention

The present invention relates to a wiper device for safety helmet, more particularly, to a wiper device for safety helmet that comprises a helmet housing, a touch device, a drive and a wiper.

(b) Description of the Prior Art

Referring to FIG. 1 and FIG. 2, when a user with a conventional safety helmet A on the head is driving on a rainy day, rainwater will stop on a glass plate A1, lowering the user's visibility. If the user wants to wipe the rainwater off with his/her hand, he/she is forced to drive with only one hand, thereby increasing the danger of driving. If an electric wiper device is added to the safety helmet, and when the user starts a control device A2, a wiper A3 will continue oscillating, making the user inattentive during driving and suffer from reduced visual acuity.

### SUMMARY OF THE INVENTION

It is the primary object of the present invention to provide a wiper device for safety helmet that comprises a helmet housing, a touch device, a drive and a wiper. When driving on a rainy day, a user's teeth occlude and come into contact with the touch device that actuates the drive through cables, thereby making the wiper oscillate on a surface of a glass plate so as to wipe rainwater off the surface of the glass plate and enhance the user's visibility and safety when driving on a rainy day.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a first perspective view of a conventional safety helmet.

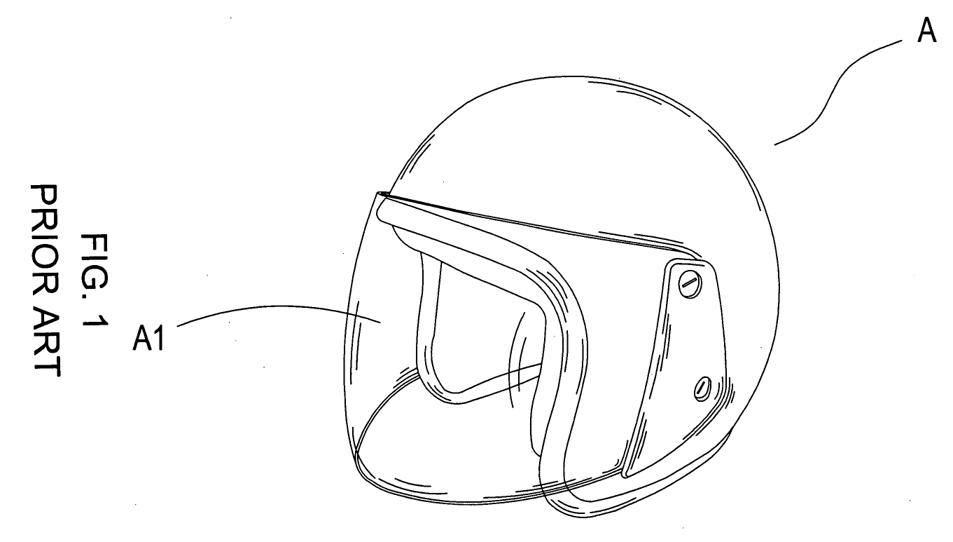

FIG. 2 shows a second perspective view of a conventional safety helmet.

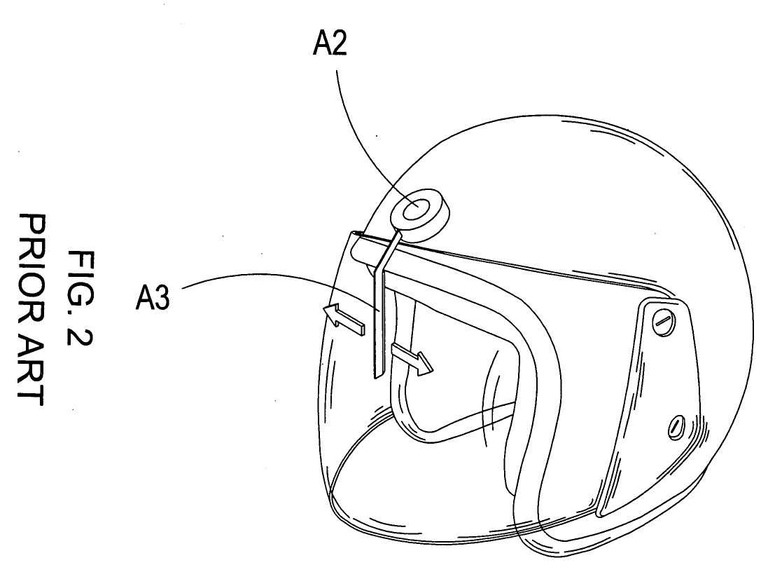

FIG. 3 shows a perspective view of the present invention.

FIG. 4 shows an exploded perspective view of the present invention.

FIG. 5 shows a first embodiment of the present invention.

FIG. 6 shows a second embodiment of the present invention.

FIG. 7 shows a third embodiment of the present invention.

### DETAILED DESCRIPTION OF THE PREFERRED EMBODIMENTS

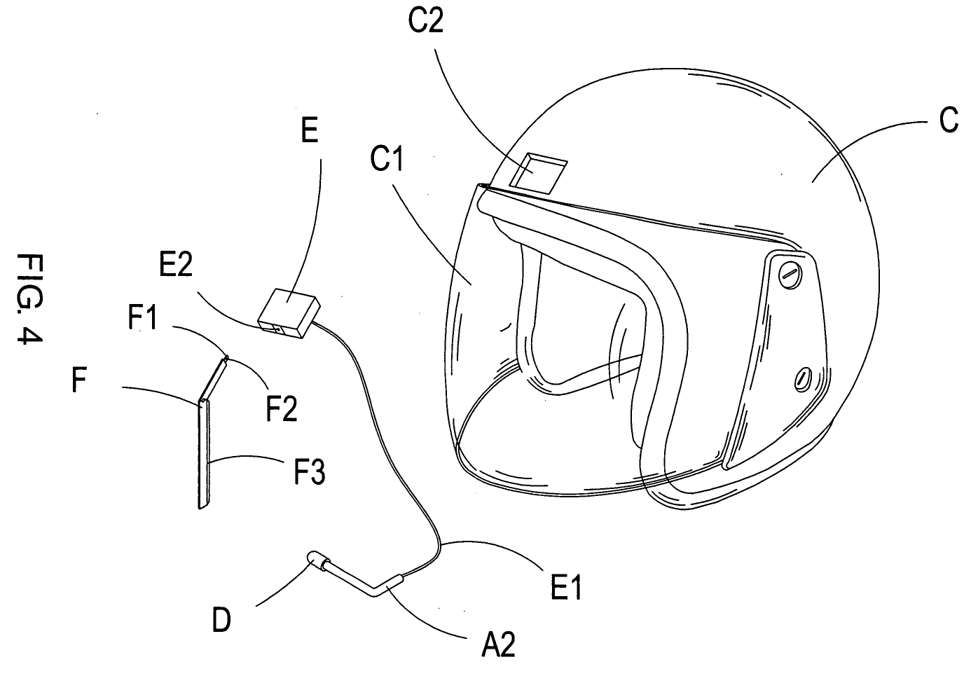

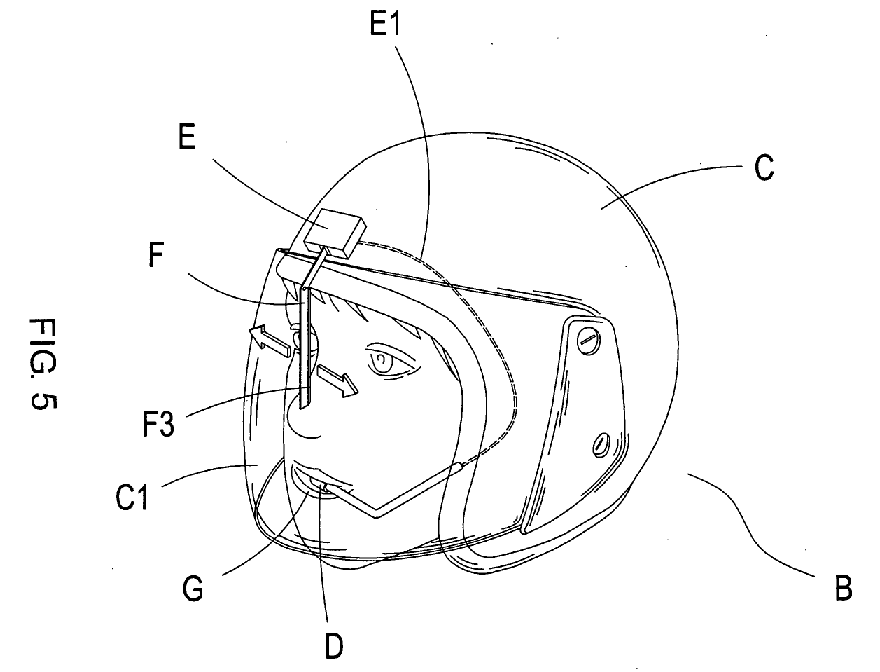

Referring to FIG. 5, if a user installs a wiper device B on a safety helmet when driving on a rainy day and if the user's teeth G occlude and come into contact with a touch device D, the touch device D actuates a drive E that is connected to a cable E1 that is then extended and connected to the touch device D. An initiator E2 (referring to FIG. 4) of the drive E is engaged with a wiper F such that the wiper F engaged on the drive E actuates. A wiping surface F3 of the wiper F becomes attached on a surface of a glass plate C1 formed on a helmet housing C and oscillates on the surface of the glass plate C1, thereby facilitating the wiping of impurities off the surface of the glass plate C1. As the number of oscillations of the wiper F corresponds to the number of occlusions made by the user's teeth G, the user can control the number of oscillations that he/she makes, thereby enhancing visibility, safety and convenience during driving.

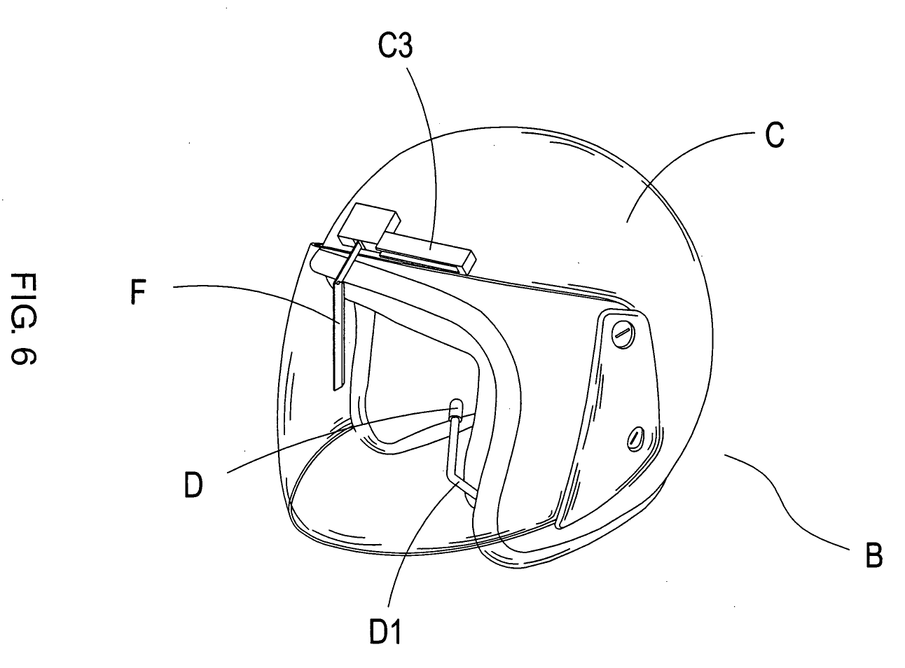

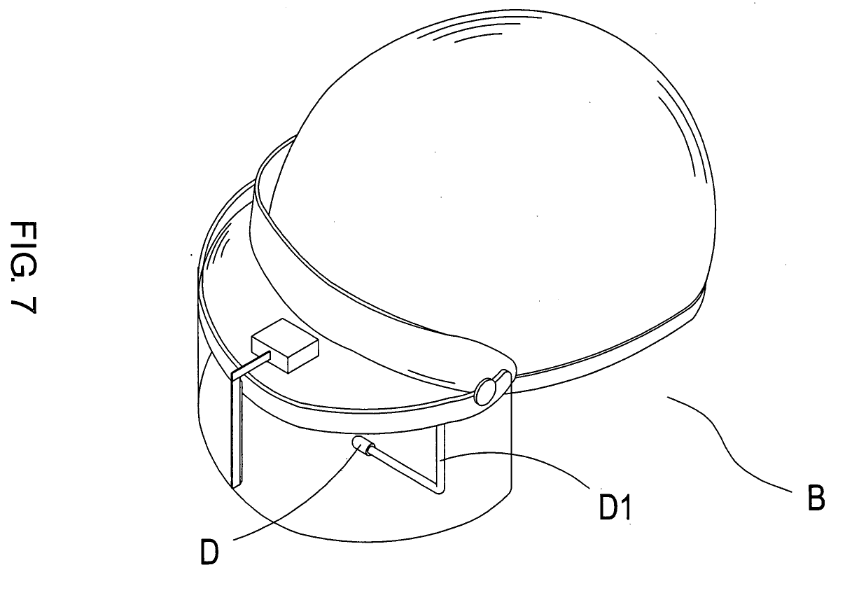

Referring to FIG. 6 and FIG. 7, a side rim of the helmet housing C is provided with a storage space C3, such that when the user stops using the wiper F, the wiper F can be stored inside the storage space C3. With the help of a retrieval shaft D1 disposed at an end of the touch device D, the touch device D is returned. Also, the wiper device B can further be installed on a full-face, half-face, construction-site or other glass-containing helmet housing.

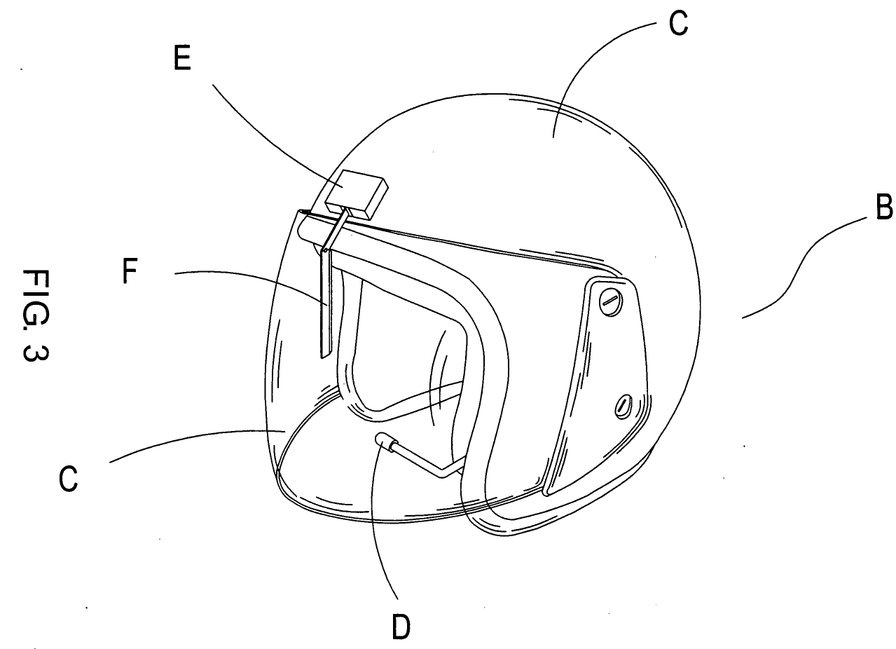

Referring to FIG. 3 and FIG. 4, an opening C2 is provided on a side rim on a top of the helmet housing C such that the drive E is installed inside the opening C2. A cable E1 is extended from an end of the drive E and connected to a touch device D from which a retrieval shaft D1 extends. A ball bearing F2 formed on a projecting shaft F1 at an end of the wiper F is engaged with an initiator E2 on the drive E, such that the initiator E2 fits into the wiper F. A side edge of the wiper F is provided with a wiping surface F3 that is attached on a glass plate C1 formed on the helmet housing C. The touch device D is actuated to make the wiper F oscillate such that the impurities on the surface of the glass plate C1 are wiped off, making the glass plate C1 clear to enhance visibility and safety.

To achieve progressiveness and practicality of the present invention, the features of the present invention are compared with those of the conventional safety helmet as follows:

Drawbacks of the conventional safety helmet:
1. The impurities attached on the glass plate on a rainy day easily affect the user's visibility.
2. he continuous oscillations of the electrical wiper make the user Tbecome inattentive during driving and suffer from reduced visual acuity.
3. It increases the user's danger during driving.
4. The cost of the electrical wiper is high.

Advantages of the present invention:
1. Capable of wiping the attached impurities off;
2. Capable of enhancing the user's visibility during driving;
3. Capable of enhancing the user's safety and convenience during driving;
4. Lower costs;
5. Progressive and practical;
6. Capable of enhancing industrial competitiveness.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A wiper device for safety helmet, comprising a helmet housing, a touch device, a drive and a wiper, wherein the drive disposed on a side rim of the helmet housing is provided with a cable that is extended and connected to the touch device comprising an initiator that is engaged with a ball bearing of the wiper; a glass plate installed on the helmet housing is tightly attached onto the wiper such that when a user's teeth occlude and come into contact with the touch device that actuates the drive, the initiator of the drive controls the wiper movements so that the wiper wipes off the impurities that block the user's visual line off the glass plate, thereby enabling the user to control the wiper oscillation when driving on a rainy day so as to enhance the user's visibility and safety.

2. The wiper device for safety helmet as claimed in claim 1, wherein the helmet housing is provided for being worn on the user's head.

3. The wiper device for safety helmet as claimed in claim 1, wherein the safety helmet is further provided with a storage space for storing the wiper when the wiper is not used.

4. The wiper device for safety helmet as claimed in claim 1, wherein the touch device can further be configured as an electrical device, a manual device, a voice-controlled device or other control devices.

5. The wiper device for safety helmet as claimed in claim 1, wherein the wiper device can further be installed on a full-face, half-face, construction-site, or other glass-containing helmet housing.

6. The wiper device for safety helmet as claimed in claim 1, wherein the wiper can further be configured as a speed-governing wiper to facilitate the user's regulation of the wiping speed.

7. The wiper device for safety helmet as claimed in claim 1, wherein the engagement of the ball bearing can further be configured as the push-button type, tongue-and-groove type, chute-type and other engagement type.

8. The wiper device for safety helmet as claimed in claim 1,.wherein a retrieval shaft is provided for collecting the drive.
